(19) United States
(12) Patent Application Publication
(10) Pub. No.: US 2025/0187928 A1
(43) Pub. Date: Jun. 12, 2025

(54) MAX PRECURSOR HAVING REDUCED OXYGEN CONTENT AND METHOD FOR PRODUCING MXENE

(71) Applicants: INNOMXENE CO.,LTD., Daejeon (KR); INDUSTRIAL COOPERATION FOUNDATION JEONBUK NATIONAL UNIVERSITY, Jeonju-si (KR); RESEARCH & BUSINESS FOUNDATION SUNGKYUNKWAN UNIVERSITY, Suwon-si (KR)

(72) Inventors: Jung-Min OH, Daejeon (KR); Moon-Sung KIM, Busan (KR); Jikwang CHAE, Daejeon (KR); Chang-Youl SUH, Daejeon (KR); Hanjung KWON, Jeollabuk-do (KR); Chong-Min KOO, Seoul (KR)

(21) Appl. No.: 18/844,661

(22) PCT Filed: Mar. 7, 2023
(86) PCT No.: PCT/KR2023/003087

§ 371 Date: Sep. 6, 2024

(30) Foreign Application Priority Data
Mar. 18, 2022 (KR) 10-2022-0034079

(51) Int. Cl. C01B 32/921

(52) U.S. Cl. CPC C01B 32/921; C01P 2002/72; C01P 2004/24

(57) ABSTRACT

The present invention pertains to a MAX precursor having a reduced oxygen content, and a method for producing MXene. A method for producing a MAX precursor according to the present invention comprises the steps of: applying a physical force to a mixture of a lower metal oxide and at least one among a nitrogen source and a carbon source; heat-treating the mixture to prepare a metal nitride or metal carbide; and synthesizing the metal nitride or metal carbide with aluminum or silicon to produce the MAX precursor.

### CROSS-REFERENCE TO RELATED APPLICATIONS

This application is the National Stage filing under 35 U.S.C. 371 of International Application No. PCT/KR2023/003087, filed on Mar. 7, 2023, which claims the benefit of Korean Patent Application No. 10-2022-0034079, filed on Mar. 18, 2022, the contents of which are all hereby incorporated by reference herein in their entirety.

### TECHNICAL FIELD

The present disclosure relates to a method for producing MAX precursor and MXene having reduced oxygen content.

### BACKGROUND ART

Recently, MXene, a new two-dimensional material that exhibits properties comparable to graphene, and a technological process for dramatically reducing manufacturing costs in manufacturing various devices using MXene have been developed.

MXene has a hydrophilic surface and high electrical and thermal conductivity, showing excellent properties in the fields of electrodes, supercapacitors, biosensors, desalination systems, and electromagnetic wave shielding.

In addition, while graphene, despite superior properties thereof, is difficult to be used as a semiconductor material due to the lack of a bandgap, MXene forms a bandgap, thus making MXene valuable as a semiconductor material.

In general, MXene is composed of transition metal carbides and nitrides or carbonitrides with the chemical formula Mₙ₊₁Xₙ. Here, M is a transition metal (e.g., Ti, Sc, Zr, Hf, V, Nb, Mo, Ta, Cr, etc.), X is carbon or nitrogen, and n is selected from 1 to 3.

This MXene is composed of transition metals and compounds of carbon and nitrogen, and the price of the transition metal accounts for 80% of the total manufacturing cost.

Therefore, there is a need to develop a technology that can produce MXene at a lower cost while maintaining high quality.

### DISCLOSURE

### Technical Problem

The present disclosure provides method for producing MAX precursor and MXene having reduced oxygen content.

### Technical Solution

An object of the present disclosure is achieved by a method for producing a MAX precursor, including: applying a physical force to a mixture of a low-grade metal oxide and at least one of a nitrogen source and a carbon source; heat-treating the mixture to prepare metal nitride or metal carbide; and synthesizing the metal nitride or metal carbide with aluminum or silicon to produce the MAX precursor.

The physical force may be applied through milling.

Through the milling, the mixture may be crushed to increase a surface area of the mixture.

By the milling, a crystal grain size of the carbon source may be reduced to 3 nm to 50 nm, and a crystal grain size of the low-grade metal oxide may be reduced to 3 to 50 nm.

By the milling, a crystal grain size of the carbon source may be reduced to 5 nm to 30 nm, and a crystal grain size of the low-grade metal oxide may be reduced to 5 nm to 30 nm.

A crystal grain size of the metal nitride or metal carbide may be 20 nm to 60 nm.

An oxygen content of the metal nitride or metal carbide may be 0.1 to 1.0% by weight.

An oxygen content of the MAX precursor may be 0.1 to 1.2% by weight.

The graphite powder may be amorphized by the milling.

The heat-treating may be performed at 1100° C. to 1400° C.

Another object of the present disclosure is achieved by a method for producing MXene, further comprising manufacturing MXene by reacting a MAX precursor manufactured according to the above-described method with an acid-based solution.

The acid-based solution may include one or more selected from among hydrofluoric acid (HF), LiHF2, NaHF2, KHF2, lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium difluoride (NH₄HF₂), and ammonium hexafluoroaluminate ((NH₄)₃AlF₆).

### Advantageous Effects

According to the present disclosure, a method for producing MAX precursor and MXene with reduced oxygen content is provided.

### DESCRIPTION OF DRAWINGS

FIG. 1 is a flowchart for explaining a method for manufacturing MAX precursor and MXene nano ink according to an embodiment of the present disclosure.

FIGS. 2A, 2B, and 2C for explaining a method for manufacturing MAX precursor according to a related art.

FIGS. 3A, 3B, 3C, 3D and 3E show a method for manufacturing MAX precursor according to the present disclosure.

FIGS. 4A, 4B, and 4C are TEM photographs showing that the crystal grain size of the mixture of TiO₂ and graphite decreases through milling.

FIGS. 5A, 5B, and 5C show the shape and X-ray analysis results of synthesized TiC.

FIGS. 6A, 6B, and 6C respectively show MXene nanosheets, water-based MXene nano ink, and MXene film manufactured in experimental examples of the present disclosure.

FIG. 7 shows the electrical conductivity of MXene films manufactured from MAX precursors with different oxygen contents.

FIG. 8 shows the effect of MAX oxygen concentration on the electromagnetic wave shielding performance of MXene film.

### MODE FOR DISCLOSURE

In the present disclosure, a transition metal is manufactured using low-cost and low-grade metal oxide. First, low-grade metal oxides are reacted with carbon and nitrogen to be synthesized into a carbide and a nitride, which are then synthesized with aluminum and silicon to produce MAX precursor (MAX precursor, MAX). The MAX precursor thus produced is reacted with an acid-based solution to disperse MXene nanosheets in H₂O or various organic solvents, ultimately producing MXene nano ink.

In the following description, titanium is mainly exemplified as the metal in the Mₙ₊₁Xₙ structure of MXene, but the metal may also be a different transition metal such as Sc, Zr, Hf, V, Nb, Mo, Ta, or Cr. X is mainly exemplified by using carbon, but X may also be nitrogen. The MAX precursor is mainly exemplified by using the Ti₃AlC₂ structure, but silicon may be used instead of aluminum.

When low-grade metal oxides react with carbon, TiC with low oxygen content is produced through a milling process or the like. Afterwards, low-oxygen TiC is synthesized with aluminum to produce a Ti₃AlC₂ MAX precursor. The synthesized Ti₃AlC₂ MAX precursor is also produced with low oxygen content. In general, oxygen is commonly considered an impurity in metals and ceramics. In a MAX precursors and MXene, the higher oxygen content degrades crystallinity, creates vacancies in the crystal, and reduces electrical conductivity. When MXene was produced using the low-oxygen Ti₃AlC₂ MAX precursor according to the present disclosure and the electrical conductivity and electromagnetic shielding performance thereof were compared, superior performance was observed.

MXene is exemplified as being produced in the form of MXene nanosheets, but the present disclosure is not limited thereto.

Hereinafter, the present disclosure will be described in detail with reference to the accompanying drawings.

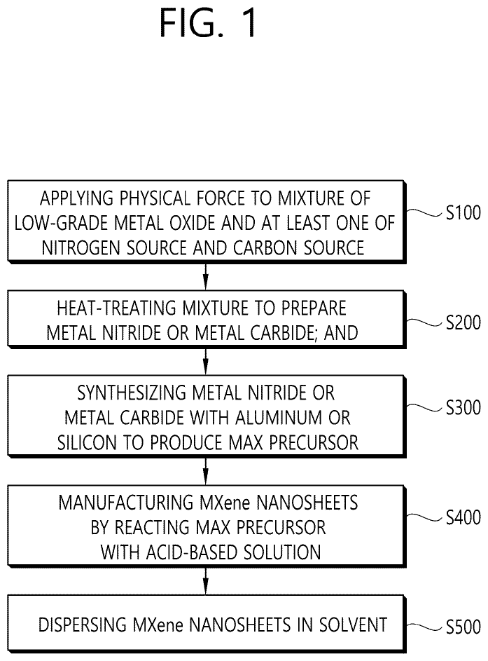

FIG. 1 is a flowchart showing a method for manufacturing a MAX precursor and MXene nano ink according to an embodiment of the present disclosure.

Physical force is applied to a mixture of at least one of a nitrogen source and a carbon source and the low-grade metal oxide (S100).

‘Nitrogen source and carbon source’ and ‘metal oxide’ may be mixed after reducing a crystal grain size by applying physical force, respectively. Additionally, physical force May first be applied to either the ‘nitrogen source and carbon source’ or the ‘metal oxide’ and then mixed, and then additional physical force may be applied to the mixture.

In low-grade metal oxides, “low-grade” usually means a purity of 99%, 98%, 97%, 96%, or 95% or less, and examples of low-grade metal oxides may include TiO₂, VO₂O₅, NbO₂, etc., but are not limited thereto.

Titanium oxide (TiO₂) powder may have a structure selected from the group consisting of rutile, anatase, and brookite, and preferably may have a rutile structure.

A particle size of the lower metal oxide may be 20 μm to 80 μm or 30 μm to 60 μm.

By using metal oxide instead of transition metal, production costs may be reduced by up to 80%, and high-purity MAX precursors may be obtained.

The carbon source (carbon powder) may be one type of powder selected from the group consisting of graphite, carbon black, carbon nanotubes, graphene, fullerene, diamond, amorphous carbon, and carbon fiber, but is not limited thereto.

A particle size of the carbon powder may be 15 μm to 80 μm, 20 μm to 70 μm, 30 μm to 60 μm, or 35 μm to 55 μm. If the particle size of the carbon powder is less than 15 μm, the carbon particles become too small after a grinding process, potentially causing a powder combustion problem, and if the particle size of the carbon powder exceeds 80 μm, the grinding process time, which will be described later, may increase.

The physical force is a force that crushes or pulverizes a mixture or makes the particles of the mixture smaller. The physical force may be applied through milling, but is not limited thereto.

The milling may be performed for 1 hour to 30 hours, 2 hours to 25 hours, 5 hours to 20 hours, or 10 hours to 15 hours.

The milling reduces the crystal grain size and reduces the oxygen content in the mixture.

The high energy induced by the milling may reduce the crystal grain size of TiO₂ and graphite in the mixture. After milling, the crystal grain size of TiO₂ in the mixture is reduced to 3 nm to 50 nm or 5 nm to 30 nm. The crystal grain size of graphite may decrease to 3 nm to 50 nm or 5 nm to 30 nm, and the regular atomic arrangement may be disrupted, leading to amorphization. In the present disclosure, the amorphization means that the amorphous component is 90% by weight or more, 95% by weight or more, or 99% by weight or more of the total.

Thereafter, the mixture is heat-treated to prepare metal nitride or metal carbide (S200). At this time, the heat-treatment temperature for synthesizing metal nitride or metal carbide is 1100° C. to 1500° C., 1100° C. to 1400° C., or 1250° C. to 1350° C., and is maintained at corresponding temperature values for 1 to 5 hours to synthesize pure metal nitride or metal carbide.

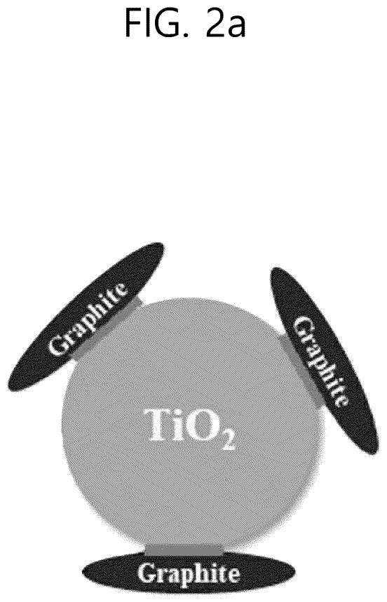

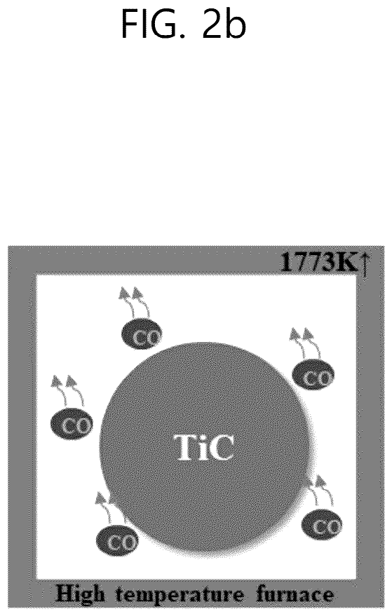

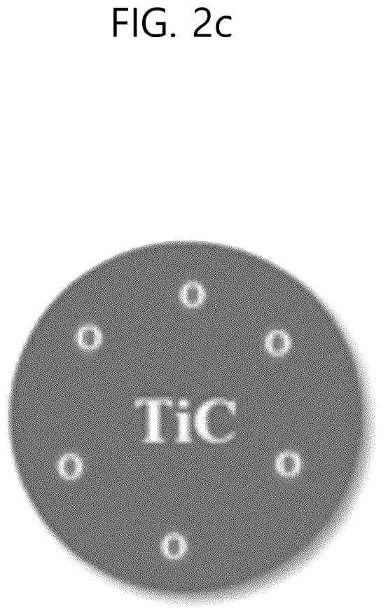

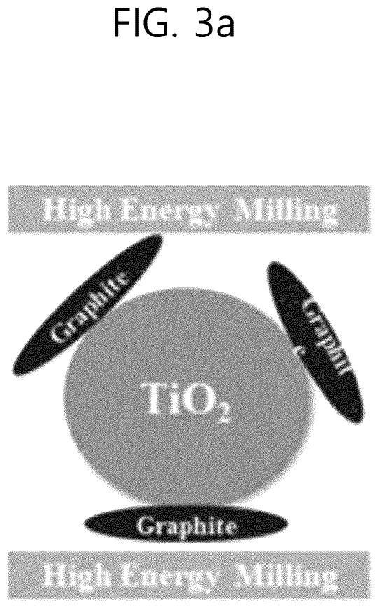

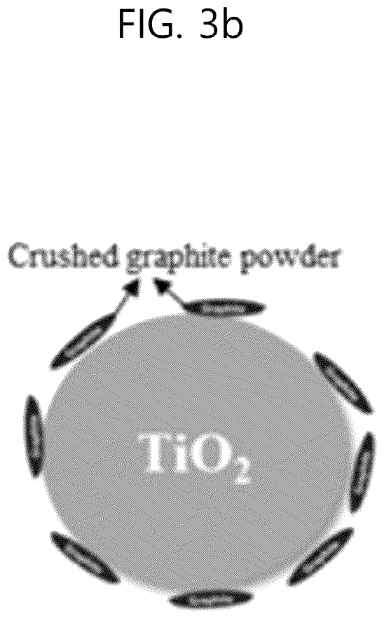

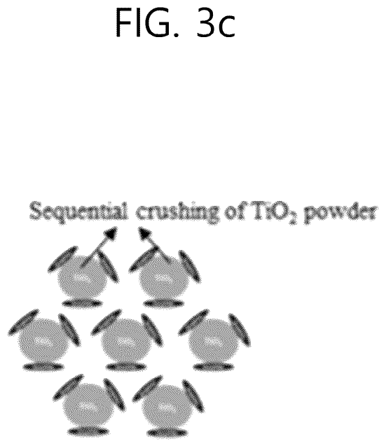

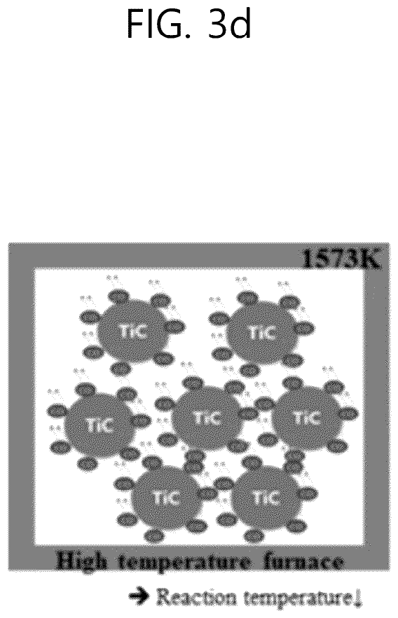

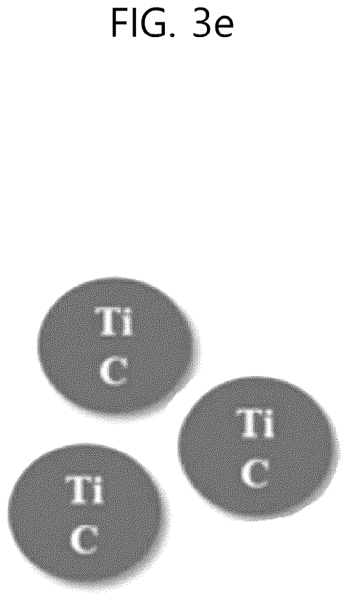

The above process will be described in detail with reference to FIGS. 2A to 2C and FIGS. 3A to 3E. FIGS. 2A to 2C show a method for manufacturing a MAX precursor according to a related art, and FIGS. 3A to 3E show a method for manufacturing a MAX precursor according to the present disclosure.

In the related art, as shown in FIGS. 2A, 2B, and 2C, titanium oxide and graphite are mixed and then heat-treated to produce a TiC precursor. The contact area between titanium oxide and graphite is narrow, resulting in (1) a small diffusion path, (2) a large driving force required for carbothermal reduction, and (3) a high amount of residual oxygen. Therefore, a high heat-treatment temperature is required, and the oxygen content of the manufactured precursor is high.

In the present disclosure, the mixture is milled and then heat-treated, as shown in FIGS. 3A, 3B, 3C, 3D, and 3E. Graphite is pulverized by milling, resulting in a reduction in crystal grain size. Although not limited to the above, the crystal grain size of graphite may decrease first, followed by a decrease in the crystal grain size of TiO₂.

With the reduction in crystal grain size, the contact area between titanium oxide and graphite increases. Increasing the contact area results in (1) a longer diffusion path, (2) a reduced driving force required for carbothermal reduction, and (3) a decreased content of residual oxygen. Accordingly, the heat-treatment temperature may be lowered.

The crystal grain size of the manufactured metal nitride or metal carbide may be 20 nm to 60 nm or 30 nm to 50 nm, and the oxygen content may be 0.05% to 2.0% by weight, 0.1% to 1.0% by weight, 0.1% to 0.5% by weight, or 0.2% to 0.8% by weight.

MAX precursor is produced by synthesizing metal nitride or metal carbide with aluminum or silicon (S300).

For aluminum, pure aluminum metal powder or Al₂O₃ may be used, and for silicon, either pure silicon metal powder or SiO₂ may be used.

Examples of MAX precursor may include Ti₂CdC, Sc₂InC, Ti₂AlC, Ti₂GaC, Ti₂InC, Ti₂TIC, V₂AlC, V₂GaC, Cr₂GaC, Ti₂AlN, Ti₂GaN, Ti₂InN, V₂GaN, Cr₂GaN, Ti₂GeC, Ti₂SnC, Ti₂PbC, V₂GeC, Cr₂AlC, Cr₂GeC, V₂PC, V₂AsC, Ti₂SC, Zr₂InC, Zr₂TIC, Nb₂AlC, Nb₂GaC, Nb₂InC, Mo₂GaC, Zr₂InN, Zr₂TIN, Zr₂SnC, Zr₂PbC, Nb₂SnC, Nb₂PC, Nb₂AsC, Zr₂SC, Nb₂SC, Hf₂InC, Hf₂TIC, Ta₂AlC, Ta₂GaC, Hf₂SnC, Hf₂PbC, Hf₂SnN, Hf₂SC, Ti₃AlC₂, V₃AlC₂, Ti₃SiC₂, Ti₃GeC₂, Ti₃SnC₂, Ta₃AlC₂, Ti₄AlN₃, V₄AlC₃, Ti₄GaC₃, Ti₄SiC₃, Ti₄GeC₃, Nb₄AlC₃, and Ta₄AlC₃, but are not limited thereto.

The heat-treatment temperature for synthesizing the MAX precursor is 1100° C. to 1600° C., and the temperature is maintained for 1 to 5 hours to synthesize pure MAX precursor powder.

For example, TiC powder, Ti metal powder, and Al powder are mixed according to the final Ti₃AlC₂ phase fraction. Each powder may be weighed and mixed as follows. (Weight ratio: TiC powder 60-62%, Ti metal powder 23-25%, Al 14-16%)

The mixed powder is formed into a green compact and loaded into a heat-treatment furnace. At this point, the size and weight of the green compact may be arbitrarily adjusted, and the pressure applied during compact production is 3,000 to 5,000 psi.

The mixed powder is made into a green compact, loaded into a heat-treatment furnace, and heat-treated to synthesize pure MAX precursor powder. At this time, the atmosphere in the furnace was controlled with an inert gas flowing at a rate of 500 to 3,000 cc/min, and argon or helium may be used as the inert gas.

The oxygen content of the obtained MAX precursor may be 0.05 to 2.0% by weight, 0.1 to 1.2% by weight, 0.1 to 0.5% by weight, or 0.15 to 1.0% by weight.

Next, MXene nanosheets are manufactured by reacting the MAX precursor with an acid-based solution (S400).

Acid-based solutions may contain fluorine atoms.

MXene nanosheets, which are high-purity MXene powder, are manufactured by removing an intermediate layer material from the MAX precursor using an acid-based solution containing fluorine atoms. The acid-based solutions containing fluorine atoms may include one or more selected from among hydrofluoric acid (HF), LiHF₂, NaHF₂, KHF₂, lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium difluoride (NH₄HF₂), and ammonium hexafluoroaluminate ((NH₄)₃AlF₆), but are not limited thereto.

Finally, MXene nano ink is manufactured by dispersing MXene nanosheets in a solvent (S500).

The MXene nano ink may be obtained by dispersing MXene nanosheets in water or an organic solvent.

The organic solvent may be one or more selected from methyl acetate, ethyl acetate, acetone, and ethanol, but is not limited thereto.

The present disclosure will be described in detail below through experimental examples.

### Manufacturing of MAX Precursor

To synthesize TiC powder, which is a precursor for MAX synthesis, TiO₂ and graphite were used as raw materials, and powder sizes of TiO₂ and graphite were in the range of 30 to 60 μm and 20 to 70 μm, respectively, and a molar ratio of TiO₂ to graphite was adjusted within the range of the range of 1:2.5 to 1:3.2.

To mix TiO₂ and graphite and reduce the powder size, milling was performed in a planetary ball mill, and the materials for the container and milling balls were stainless steel and carbide, respectively. The milling process for mixing and powder size reduction was carried out within the range of 5 to 20 hours, and the mass ratio of balls to the sample was in the range of 10:1 to 40:1.

The crystal grain size of the TiO₂/graphite mixture whose powder size was reduced through the milling process was in the range of 5 to 30 nm, and the TiO₂/graphite mixture is heat-treated under vacuum atmosphere in the range of 10-4 to 10-3 Tor and then synthesized into TiC.

During the TiC synthesis process, the heat treatment temperature was in the range of 1250 to 1350° C., and the holding time at this temperature ranged from 1 to 3 hours, and the crystal grain size of the TiC synthesized from the TiO₂/graphite mixture was in the range of 30 to 50 nm.

The manufactured TiC powder, Ti metal powder, and Al powder were mixed according to the final Ti₃AlC₂ phase ratio. Each powder was weighed and simply mixed as follows. (Weight ratio: TiC powder 60-62%, Ti metal powder 23-25%, Al 14-16%)

This mixed powder was then manufactured into a green compact and loaded into a heat treatment furnace. At this point, the size and weight of the green compact were arbitrarily adjusted, and the pressure when manufacturing into the green compact was 3,000-5,000 psi.

After the mixed powder was pressed into the green compact and loaded into the heat treatment furnace, the heat treatment temperature for MAX synthesis was between 1400° C. and 1500° C. and the temperature was maintained for 1 to 5 hours to synthesize pure MAX powder. The atmosphere in the furnace was controlled with an inert gas flowing at a rate of 500-3,000 cc/min, and argon or helium was used as the inert gas.

### MXene Nanosheet Manufacture

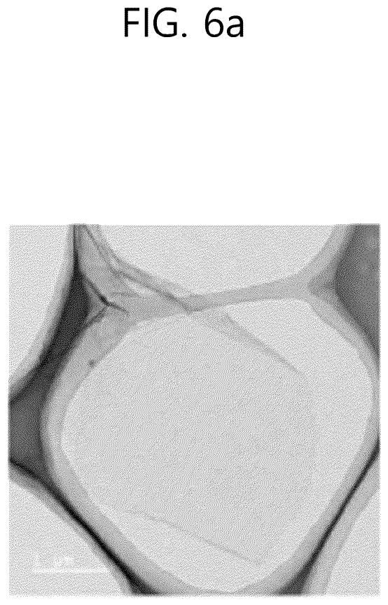

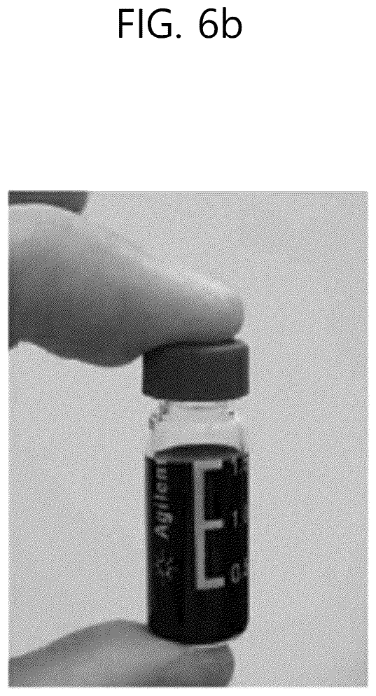

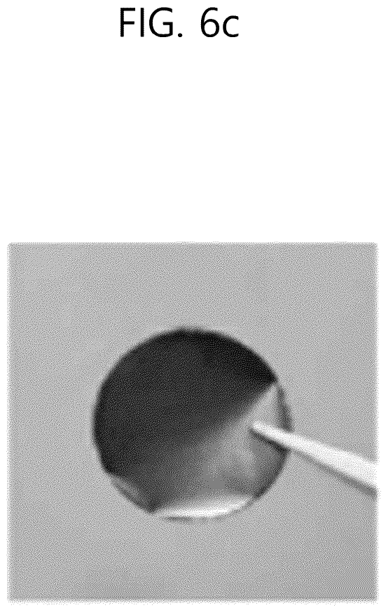

(Based on 1 g of MAX precursor powder) First, an etching solution was manufactured with 1.6 g of LiF, 4 ml of distilled water, and 18 ml of hydrochloric acid (9M), and 1 g of MAX precursor powder was then added to the solution and maintained at a temperature of 35 to 45° C. and stirred at 200-500 rpm for 24 to 48 hours. After the reaction, centrifugation was performed at 3000-5000 rpm for 5 to 30 minutes at 10 to 20° C. to recover the precipitate. Afterwards, distilled water was added to the precipitate and centrifugation was performed several times under the above conditions until the pH of the supernatant reached 5 or higher. At this time, if the pH exceeded 5, the supernatant was discarded, and the precipitate was recovered to obtain MXene nanosheets (see TEM photo of MXene nanosheets in FIG. 6A).

### Manufacturing of MXene Nanoink

Nano ink was manufactured by dispersing the MXene nanosheet precipitate, manufactured through the above experiment, in an appropriate solvent. In this experiment, nano ink was manufactured by dispersing MXene nanosheets in distilled water at a concentration of 0.5 wt. % (see the photo of water-based MXene nano ink in FIG. 6B).

### Manufacturing of MXene Film

A film was manufactured using the MXene nano ink manufactured above through vacuum filtering. A size of a filter used in film production is 30 mm, with pores of 1 μm. At this time, the size of the filter may be adjusted arbitrarily, but the pore size is usually smaller than a cross-sectional area of the MXene nanosheet. Once the MXene film was formed through vacuum filtration, the MXene film was dried in a vacuum heat treatment device at a temperature of 45° C. to 75° C. for 1 to 3 hours. When the solvent is completely volatilized through vacuum heat-treatment, MXene self-assembles due to the unique properties of two-dimensional materials, thereby producing a stable film (see the photo of MXene film in FIG. 6C).

Changes in TiO₂ Crystals and Graphite Forms with Milling Time

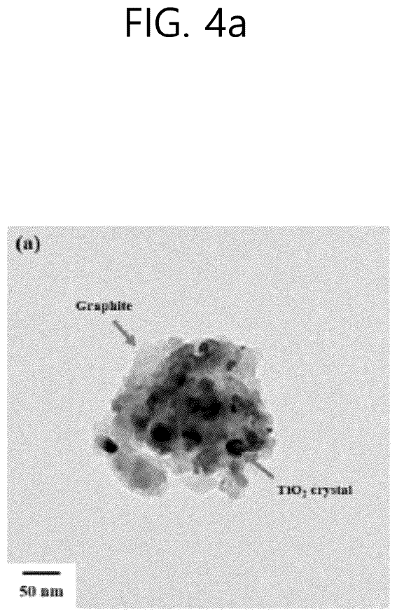

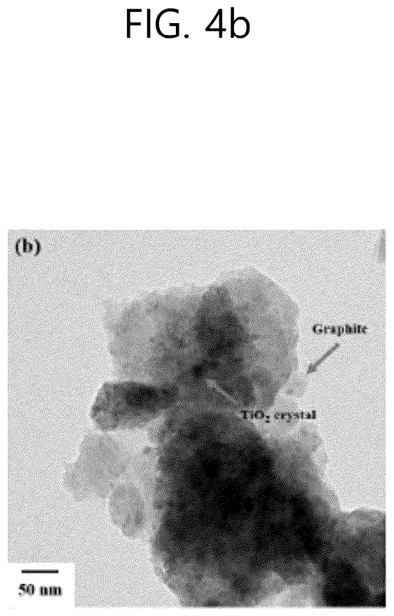

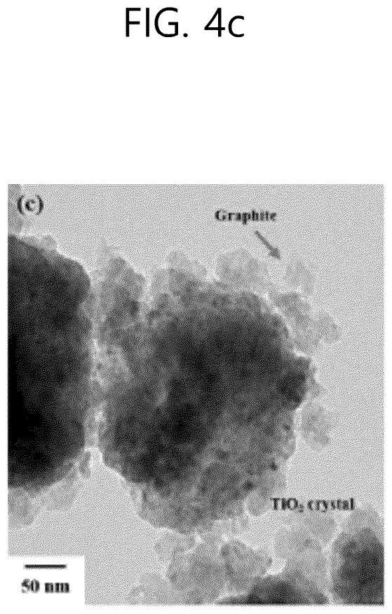

FIGS. 4A, 4B, and 4C are TEM photos showing that the crystal grain size of a mixture of TiO₂ and graphite decreases through milling. As the milling time increases from 5 hours (FIG. 4A) to 10 hours (FIG. 4B) and 20 hours (FIG. 4C), the size of the TiO₂ grains decreases, so it may be observed that, after 5 hours of milling, the TiO₂ grain size was 20-30 nm, but after 20 hours of milling, the TiO₂ grain size reduced to less than 10 nm.

### Carbothermal Reduction Behavior According to Milling Time

To confirm the carbonation reduction behavior of TiO₂/C mixture according to milling time, the amount of CO gas generation according to temperature was measured. It was confirmed that through milling, the carbonation reduction temperature of TiO₂ may be lowered than a temperature in conventional methods (above 1500° C.), and that when the milling time increases from 5 hours to 20 hours, TiO₂ carbonation reduction may be completed at a temperature below 1300° C. In doing so, it may be predicted that a low carbothermal reduction temperature may be applied, resulting in the synthesis of TiC with a smaller particle size, and that the amount of oxygen in the synthesized TiC may also be reduced compared to the raw materials without milling. In other words, TiC, which is composed of small crystal grains and has a low oxygen content, may be synthesized by milling.

### Position of Oxygen in MAX Precursor

To determine where oxygen exists in MAX powder synthesized using TiC, SEM/EDS analysis was performed. By checking the oxygen distribution in a cross-section sample of MAX powder with relatively high or low oxygen content, it was confirmed that oxygen exists inside the carbide, not on the surface.

### Graphite Form in MAX Precursor

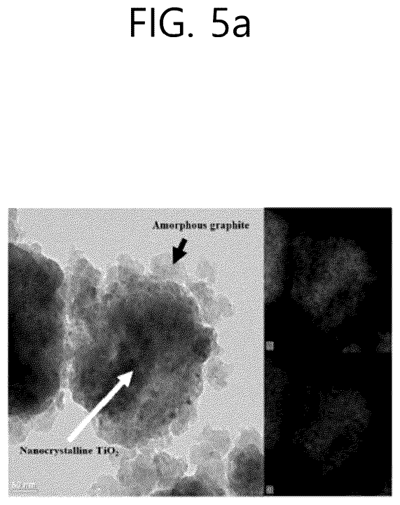

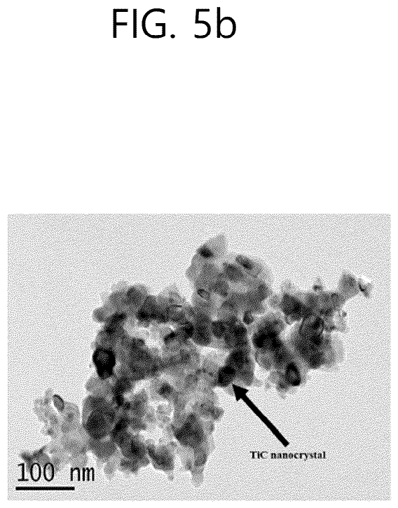

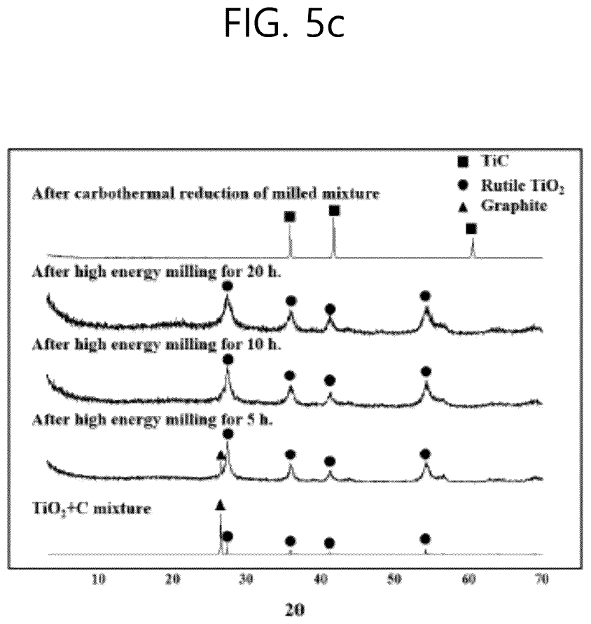

FIGS. 5A, 5B, and 5C show the shape of the synthesized TiC and the results of X-ray analysis, indicating that the crystal grains of TiC synthesized after milling are nanoscale of less than 50 nm. The XRD results show that the graphite becomes amorphous (with XRD peaks disappearing) after milling for 10 hours. Based on the XRD results, it may be inferred that the reason for the reduced carbothermal reduction temperature after 10 hours is the amorphization of the graphite.

### Physical Properties of MXene Films

Table 1 shows the oxygen content measured in TiC manufactured by milling TiO₂ and graphite for 5 to 20 hours, followed by heat treatment at 1300° C. for 2 hours. Afterwards, the oxygen content in MAX powder manufactured from TiC with different oxygen contents was measured and shown in Table 2. To measure oxygen content, 0.1 grams of each TiC and MAX powder were sampled and analyzed using LECO TCH-600 equipment.

As shown in Table 2, it was confirmed that the MAX precursor manufactured according to the present disclosure has a lower oxygen content compared to commercial products.

TABLE 1

| TiC powder | Milling time | Oxygen content (wt. %) |
|---|---|---|
| TiC from TiO₂ (#1) | 5 h | 0.89 |
| TiC from TiO₂ (#2) | 10 h | 0.76 |
| TiC from TiO₂ (#3) | 15 h | 0.44 |
| TiC from TiO₂ (#4) | 20 h | 0.12 |

TABLE 2

| MAX powder | Oxygen content (wt. %) |
|---|---|
| Commercial MAX phase | 1.39 |
| MAX phase formed from TiC (#1) | 1.0 |
| MAX phase formed from TiC (#2) | 0.8 |
| MAX phase formed from TiC (#3) | 0.5 |
| MAX phase formed from TiC (#4) | 0.15 |

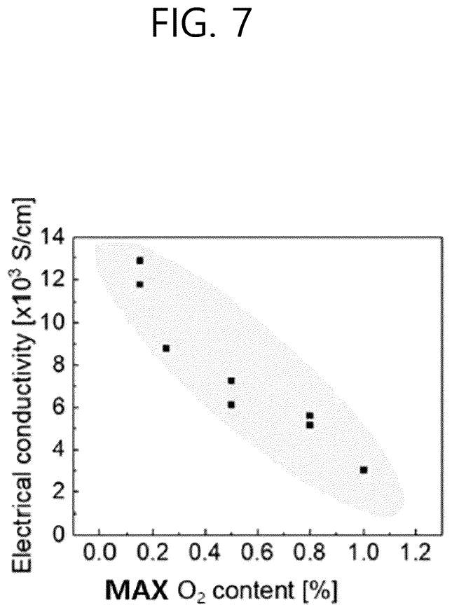

FIG. 7 shows the electrical conductivity of MXene film manufactured from MAX precursors with varying oxygen contents. It may be seen that as the oxygen content in the MAX precursor decreases, the electrical conductivity improves.

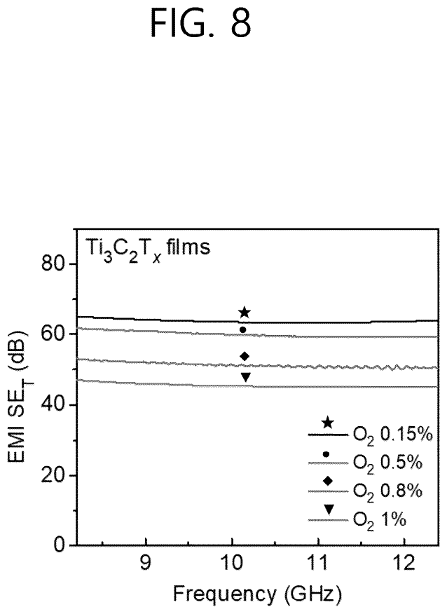

FIG. 8 shows the effect of oxygen concentration of MAX on the electromagnetic wave shielding performance of MXene film. It may be seen that as the oxygen content in the MAX precursor decreases, the electromagnetic shielding performance improves.

The embodiments of the present disclosure described above and shown in the drawings should not be construed as limiting the technical idea of the present disclosure. The scope of protection of the present disclosure is limited only by the matters stated in the claims, and those skilled in the art may improve and change the technical idea of the present disclosure into various forms. Therefore, such improvements and changes will fall within the scope of protection of the present disclosure as long as they are obvious to those skilled in the art.

1. A method for manufacturing a MAX precursor, the method comprising:
applying a physical force to a mixture of a low-grade metal oxide and at least one of a nitrogen source and a carbon source;
heat-treating the mixture to prepare metal nitride or metal carbide; and
synthesizing the metal nitride or metal carbide with aluminum or silicon to produce the MAX precursor.

2. The method of claim 1, wherein the physical force is applied through milling.

3. The method of claim 1, wherein the mixture is crushed through the milling to increase a surface area of the mixture.

4. The method of claim 1, wherein due to the milling, a crystal grain size of the carbon source is reduced from 3 nm to 50 nm and a crystal grain size of the low-grade metal oxide is reduced to 3 to 50 nm.

5. The method of claim 4, wherein due to the milling, a crystal grain size of the carbon source is reduced from 5 nm to 30 nm and a crystal grain size of the low-grade metal oxide is reduced to 5 nm to 30 nm.

6. The method of claim 4, wherein a crystal grain size of the metal nitride or metal carbide is 20 nm to 60 nm.

7. The method of claim 6, wherein an oxygen content of the metal nitride or metal carbide is 0.1 to 1.0% by weight.

8. The method of claim 7, wherein an oxygen content of the MAX precursor is 0.1 to 1.2% by weight.

9. The method of claim 4, wherein the graphite powder is amorphized by the milling.

10. The method of claim 4, wherein the heat-treating is performed at 1100° C. to 1400° C.

11. A method for manufacturing MXene, further comprising:
manufacturing MXene by reacting the MAX precursor manufactured according to claim 1 with an acid-based solution.

12. The method of claim 11, wherein the acid-based solution comprises one or more selected from among hydrofluoric acid (HF), LiHF₂, NaHF₂, KHF₂, lithium fluoride (LiF), sodium fluoride (NaF), magnesium fluoride (MgF₂), strontium fluoride (SrF₂), beryllium fluoride (BeF₂), calcium fluoride (CaF₂), ammonium fluoride (NH₄F), ammonium difluoride (NH₄HF₂), and ammonium hexafluoroaluminate ((NH₄)₃AlF₆).
